(19) United States
(12) Patent Application Publication
(10) Pub. No.: US 2007/0055930 A1
(43) Pub. Date: Mar. 8, 2007

(54) Tool for monitoring rules for a rules-based transformation engine

(75) Inventors: Stanley K. Jerrard-Dunne, Leopardstown (IE); Bill Looby, Rathfarnam (IE); James Ryan, Dublin (IE)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/221,184

(22) Filed: Sep. 7, 2005

(51) Int. Cl. G06F 17/00

(52) U.S. Cl. 715/523

(57) ABSTRACT

A tool and method for monitoring a transformation of source markup by a rules-based transformation engine are provided. The transformation engine comprises a matching component, for scanning the source markup and generating edit information in accordance with a set of rules, and a transforming component, for transforming the source markup into transformed markup in accordance with the rules. The tool comprises a text modifier for receiving the source markup, transformed markup, and edit information. The text modifier modifies the source markup and/or transformed markup in accordance with the edit information such that rendering of the modified markup produces a page displaying the markup and highlighting those portions affected by transformations. The tool may be implemented in a reverse proxy mechanism to show how content has been transformed by the transformation engine and by which particular rules, in order to debug the dynamic proxying of markup content sent by backend servers.

### BACKGROUND OF THE INVENTION

1. Field of the Invention

The present invention relates to the field of data processing and in particular to a tool for monitoring rules for a rules-based transformation engine.

2. Related Art

The World Wide Web is the Internet's multimedia information retrieval system. In the web environment, client machines communicate with web servers using the HyperText Transfer Protocol (HTTP). The web servers provide users with access to files such as text, graphics, images, sound, video, etc., using a markup language such as HyperText Markup Language (HTML). HTML provides basic document formatting and allows the developer to specify connections known as hyperlinks to other servers and files. In the Internet paradigm, a network path to a server is identified by a resource address called a Uniform Resource Locator (URL) having a special syntax for defining a network connection. So-called web browsers, for example, Netscape Navigator (Netscape Navigator is a registered trademark of Netscape Communications Corporation) or Microsoft Internet Explorer (Microsoft and Internet Explorer are trademarks of Microsoft Corporation), which are applications running on a client machine, enable users to access information by specification of a link via the URL and to navigate between different HTML pages.

When the user of the web browser selects a link, the client machine issues a request to a naming service to map a hostname (in the URL) to a particular network IP (Internet Protocol) address at which the server machine is located. The naming service returns an IP address that can respond to the request. Using the IP address, the web browser establishes a connection to the server machine. If the server machine is available, it returns a web page. To facilitate further navigation within the site, a web page typically includes one or more hypertext references known as “links.”

For improved security, reverse proxy (also called IP-forwarding) topologies may be used. These use a reverse proxy server to represent a secure content server to outside clients. Outside clients are not allowed to access the content server; their requests are sent to the reverse proxy server instead, which then forwards the client requests to the content server. The content server forwards the requests to the applications or application servers for processing. The reverse proxy server returns the completed request to the client while hiding the identity of the portal and application servers from the client. This prevents the outside clients from obtaining direct, unmonitored access to the real content server.

Most reverse proxy systems use a simple configuration where HTML rewriting can be turned on or off and the definition of what is rewritten is “hard-wired.” For example, the IBM® WebSphere® Edge Server uses a “Junction Rewrite” setting.

Some reverse proxy servers use rules-based transformation engines to proxy the content from backend servers. A set of rules can be used to specify what content is transformed as well as how it is transformed, in order to achieve such proxying. For example, URLs referring to the content server will be transformed to refer to the reverse proxy server, such that future requests from client systems will address the reverse proxy server.

During the development of such systems, administrators need to be able to find and correct errors in the set of rules. An HTTP packet tracking utility can be used to show what requests are made to a backend server, and what content is returned. However, there is a need for an improved tool which eases the burden of finding and correcting errors.

### SUMMARY OF THE INVENTION

A first aspect of the invention provides a method of monitoring a transformation of source markup by a rules-based transformation engine. The method comprises storing a set of rules, scanning the source markup, generating edit information in accordance with the set of rules, and transforming the source markup into transformed markup in accordance with the rules. At least one of the source markup and transformed markup are modified in accordance with the edit information, and the modified markup is rendered to highlight those portions affected by transformations.

A second aspect of the invention provides a rules-based transformation engine for transforming source markup in accordance with a set of rules. The transformation engine comprises a matching component for scanning the source markup and generating edit information in accordance with a set of rules. A transforming component transforms the source markup into transformed markup in accordance with the rules, and a text modifier receives the source markup, transformed markup, and edit information, and modifies at least one of the source markup and transformed markup in accordance with the edit information. A rendering component renders the modified markup to highlight those portions affected by transformations in a user display.

A further aspect of the present invention provides a tool for monitoring the transformation of source markup by a rules-based transformation engine as described above. The monitoring tool comprises a text modifier for receiving the source markup, transformed markup, and edit information and which modifies the source markup and/or transformed markup in accordance with the edit information. The modified markup can then be rendered by a rendering component in a format which highlights those portions affected by transformations.

The tool may be implemented in a reverse proxy mechanism and may also comprise a logging component for recording requests to a backend server and responses returned, as well as for storing the modified markup produced by the text modifier.

Embodiments of the invention provide a visual tool which is capable of showing how content has been transformed by a rules-based transformation engine and by which particular rules, in order to debug the dynamic proxying of markup content sent by backend servers. Users can see all requests that are made to the backend server. For each request, the time and URL of the request is shown, a response code, such as an HTTP response code, and the content type, such as the Multipurpose Internet Mail Extensions (MIME) type, of the response. For responses transformed by the rules-based transformation engine a link to representations of the source and transformed HTML is provided, in which the HTML content is modified to highlight any text affected by the transformation engine. Selection of a portion of highlighted text, for example by hovering a cursor over the text using a cursor control device such as a mouse, leads to the display of a “pop-up” message stating what rule was applied.

The present invention thus enables users to dynamically debug HTML content sent back by the backend servers and to see the requests made to the backend server, the status of each request, what content is transformed, how it is transformed, and by what particular rules.

### BRIEF DESCRIPTION OF THE DRAWINGS

Various embodiments of the present invention will now be described by way of example only, with reference to the accompanying drawings in which:

FIG. 1 shows a computer system in which an embodiment of the present invention may be implemented;

FIG. 2 shows an example of a preview page which may be displayed in a debug feature according to an embodiment of the present invention;

FIG. 3 shows an example of a requests page which may be displayed;

FIG. 4 shows an example of rendered modified source HTML;

FIG. 5 shows an example of rendered modified transformed HTML; and

FIG. 6 shows an example of a schematic and simplified representation of an illustrative implementation of a transformation engine according to an embodiment of the present invention.

### DETAILED DESCRIPTION OF THE INVENTION

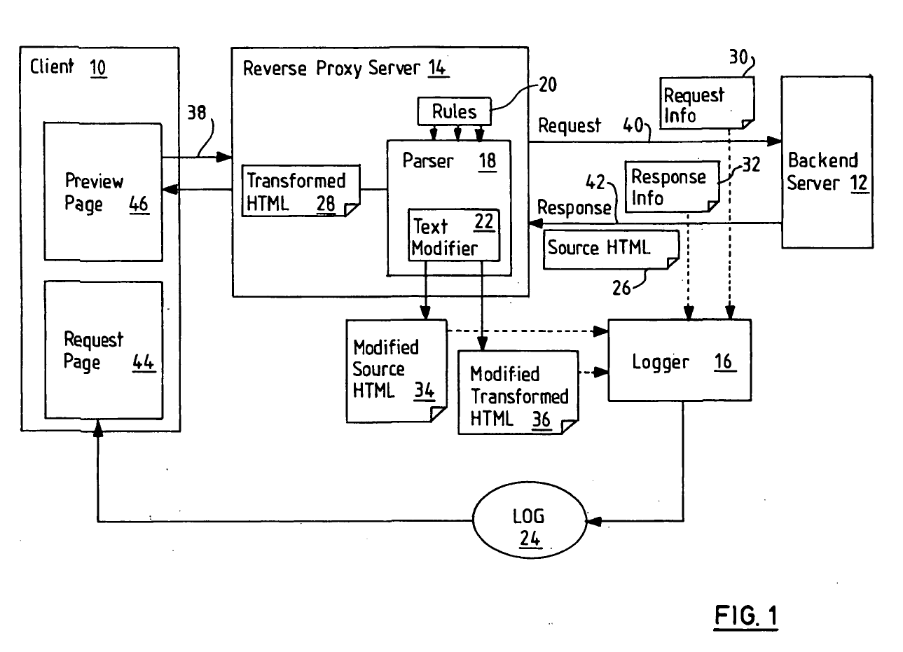

FIG. 1 discloses a computer system in which an embodiment of the present invention may be implemented. The system comprises a client computer system 10 interacting with a backend server 12 via a reverse proxy server 14. The backend server 12 hosts the content required by the client 10 and the reverse proxy server 14 makes requests and receives responses from the backend server 12, and proxies the content through to the client 10. The responses issued by the backend server 12 contain HTML called “source HTML.”

The reverse proxy server 14 is hosted on a portal server, which is operable to execute a web application which arranges web content into a portal page containing one or more portlets. A portlet is a web component which processes and generates dynamic web content. The portal aggregates this content, often called a fragment, with content from other portlets to form a portal page. The content generated by a portlet may vary from one user to another depending on the user configuration for the portlet. A portal can act as a gateway to one or more backend software applications. The portal can be used to deliver customised application content, such as forums, search engines, email and other information, within a standard template and using a common user interface mechanism. Users can be offered a single, personalised view of all the backend applications with which they work and can obtain access to a plurality of those backend applications through a single security sign-on.

The reverse proxy server 14 intercepts browser requests 38 from a browser on the client 10 and then redirects them to the backend server 12. When a portal page is requested by the browser, all portlets appearing on the requested page are called. The “real” address is determined and a request 40 is made to the backend server 12 by the reverse proxy server 14. The backend server 12 generates the requested content and sends a response 42 containing this content back to the reverse proxy server 14.

A transformation engine 18 (shown as “parser” in FIG. 1) transforms content sent by the backend server 12 according to a set of rules 20, which dictate what content gets transformed, and how, and are typically stored in the form of a list.

In the reverse proxy example of this embodiment, the transformation engine 18 converts any references to the backend server 12 into references to the reverse proxy server 14. This ensures that future requests from the browser will be sent to, and thus intercepted by, the reverse proxy server 14. The transformed HTML 28 is then returned to the browser.

The reverse proxy server 14 also comprises a text modifier 22 that is used in conjunction with the transformation engine 18 and the rules 20, to record transformations made when a debug feature is activated. When the debug feature is switched on, as the transformation engine 18 transforms the backend content (source HTML 26), the text modifier 22 simultaneously creates two extra scripts, namely a Modified Source HTML 34 and a modified transformed HTML 36.

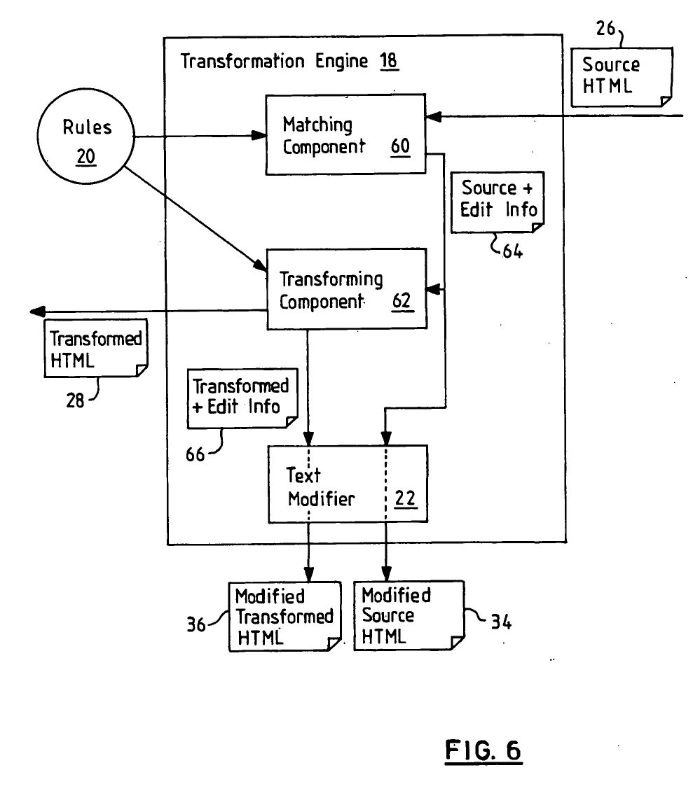

This process will be described in more detail with reference to FIG. 6, which shows the components of the transformation engine 18, namely a matching component 60, a transforming component 62, and the text modifier 22. The matching component 60 parses the source HTML 26 and uses the rules 20 to find certain character strings in the source HTML 26. The matching component 60 generates markers which identify the beginning and end of each matching character string as well as the rule 20 to which the string matches. The transforming component 62 then uses this generated information, shown as “edit information 66” in FIG. 6, to replace the matching character strings.

The rules 20 comprise a list of regular expression patterns, which can be used to identify particular patterns of code, each regular expression pattern having a corresponding “output model” which defines how a matched pattern of code is to be rewritten. The rules 20 indicate whether or not the search for each regular expression pattern in the received content is case sensitive. The regular expression patterns use certain characters, such as “.”, “*” and “?”, to represent wild card characters or wild card character strings (see, for example, http://jakarta.apache.org/regexp for more information).

One example of a matching pattern and its use by the matching and transforming components 60, 62 will now be explained below:
An input string:
INPUT: <A href=“/mail/adunne.nsf/($Inbox)?Openview”>Inbox</A>matches the pattern:
PATTERN: href=“(.*?)”with the character string: “/mail/adunne.nsf/($Inbox)?Openview” matching the pattern:
“(.*?)”, according to the wild character rules.
If the output model for this pattern is:
OUTPUT MODEL: href=“@proxyhrefurl(1)”
   The matched character string then becomes the argument “(1)” of the output model. The output model indicates how a matched character string is to be rewritten by the transforming component 62. In this case the “@proxyhrefurl” portion of the Output Model indicates that the name of the proxy server (myportal/sproxy) is to be added into the link before the matched argument (1). The resulting rewritten character string would be: RESULT:
<A ref=“myportal/sproxy/mail/adunne.nsf/($Inbox)?OpenView”>Inbox</A>.

The matching component 60 may insert the markers and rule information into the source HTML 26 to provide a combined document 64, or it may provide this edit information separately to the source HTML 26. The source HTML 26 and edit information is passed to the transforming component 62 as well as to the text modifier 22. The transforming component 62 transforms the source HTML 26 according to the rules 20 using the edit information supplied and outputs the transformed HTML 28. Additionally, it passes the transformed HTML 28 and its associated edit information 66, to the text modifier 22.

The text modifier modifies the HTML 66, 64 it receives by escaping out the HTML tags so that it can be printed on a screen. Escape sequences, also known as character entities, are used to insert special characters, such as the left angle bracket (<), the right angle bracket (>), and the ampersand (&), which have special meanings in HTML, into an HTML document. The angle brackets are used to indicate the beginning and end of HTML tags, and the ampersand is used to indicate the beginning of an escape sequence. The text modifier escapes out the tags by replacing the left and right angle brackets with their respective escape sequences: &lt; for <; and &gt; for >. Thus, a browser will then display the tags as part of the HTML text, rather than interpreting them.

The text modifier 22 also uses the edit information to add new HTML tags to highlight the text which will be or has been transformed by the transformation engine 18. It may also add markup content to enable a pop-up message to be presented when a user selects a particular piece of highlighted text, for example by hovering a cursor over the text, the pop-up identifying which rule will be (in the modified source HTML 34) or was (in the modified transformed HTML 36) applied to transform that text by the transformation engine 18.

The text modifier generates the modified Source HTML 34 from the source HTML 26 and edit information 64, and generates the modified transformed HTML 36 from the transformed HTML 28 and edit information 66.

The system also comprises a logger 16 that logs relevant information including request info 30, response info 32, modified source HTML 34, and modified transformed HTML 36 in a log 24. The request info 30 comprises data identifying a particular request such as the time sent and URL to which it is addressed. The response info 32 comprises data such as HTTP response code and MIME-type of the response. HTTP response codes are grouped into a number of different series:

200-series HTTP response codes indicate that the request was processed without any error conditions;

300-series response codes indicate that the document requested has moved to some other location, or that the browser is being redirected for some other reason;

400-series messages indicate that the browser did something wrong; and

500-series messages indicate that something went wrong on the server.

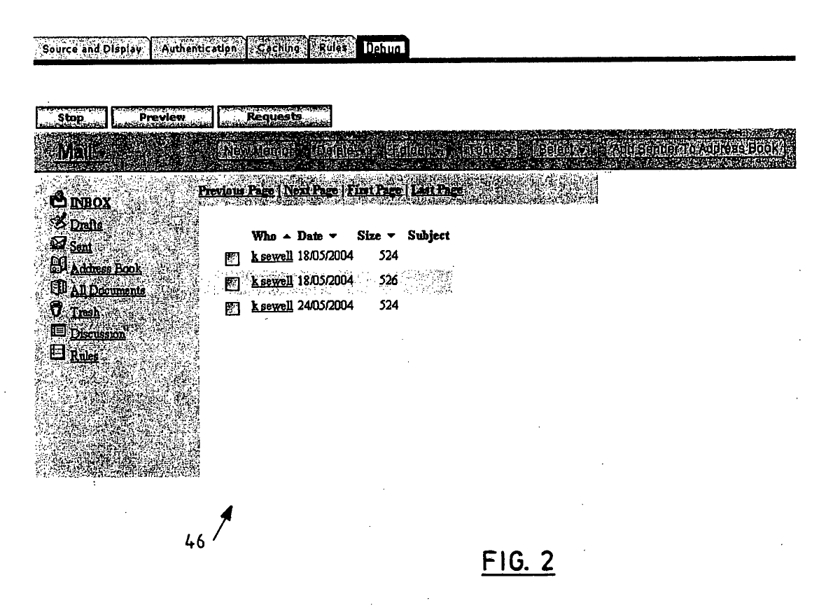

In the debug feature, a user interface comprising preview and request pages 46, 44 may be provided to a system administrator. The preview page 46, an example of which is shown in FIG. 2 in respect of a backend mail application, displays the content from the backend application which is proxied through the reverse proxy server 14. The user can use this preview screen to interact with the mail application. User requests are sent from the client 10 to the reverse proxy server 14. The reverse proxy server 14 forwards these requests to the backend server 12. The backend server 12 returns with a response which includes the source HTML 26. The source HTML 26 is parsed by the transformation engine 18, which uses the rules 20 to transform certain parts of the source HTML 26. The transformed HTML 28 is sent back to the client 10 to be rendered in the preview page 46.

When the debug mode is active, the text modifier 22 creates modified source HTML 34 and modified transformed HTML 36 content. The logger 16 is then called to log the request info 30 and response info 32, the modified source HTML 34, and the modified transformed HTML 36 for this particular request.

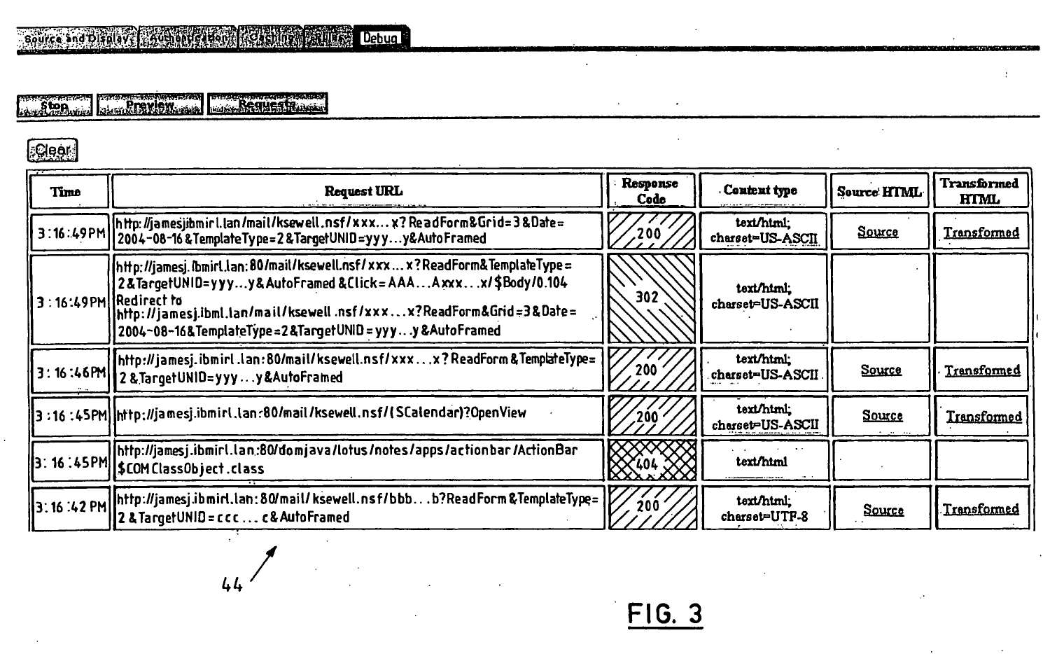

The user may then switch to the requests page 44, an example of which is shown in FIG. 3, to view a log of the requests that have been made to the backend server 12. For each request, the user can see the time it was sent, the request URL, the HTTP response code received in the response, and the type of the request content (e.g., MIME type), as well as links to the modified source HTML 34, and the modified transformed HTML 36, where appropriate. HTTP response codes are used by the debug tool to highlight particular requests, and thus the rules 20 used thereon, which may require review by the user. The response code entry may be colour coded (shown in FIG. 3 by different cross-hatchings) according to the series to which the response code belongs, in order to highlight those requests which returned an error. The user can then look into the problem by selecting the links to the source and transformed HTML 34, 36.

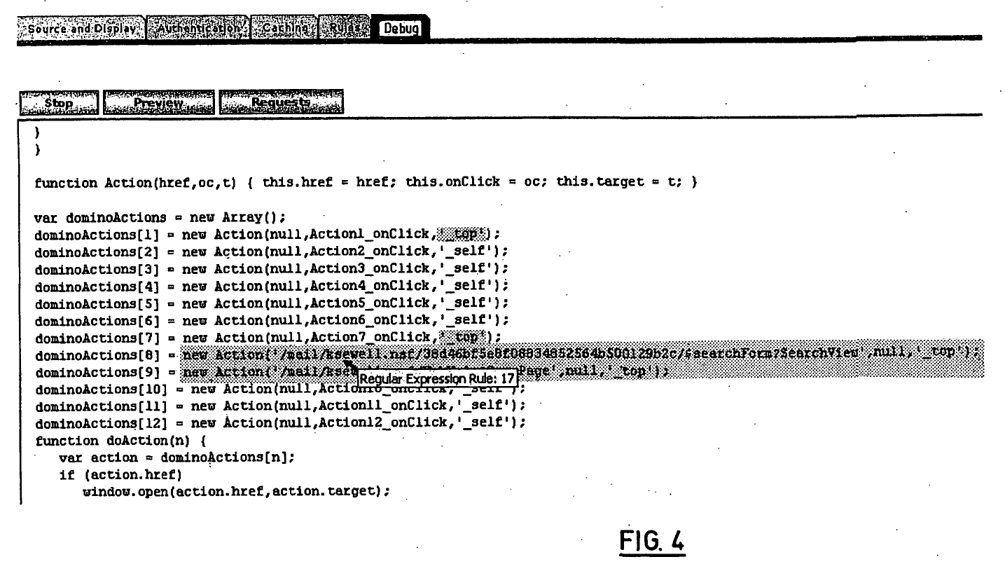

For example, for a given request, clicking on the “Source” link on the request page 44 will bring up a screen such as that shown in FIG. 4, which is produced by rendering the modified source HTML 34. This screen displays in text format the HTML returned by the backend server 12 before transformation. Text that will be transformed by the transformation engine 18 is highlighted. By hovering the cursor over a particular piece of highlighted code (or selecting a section of text in any other manner) the user causes display of a pop-up message indicating the rule 20 which will be applied.

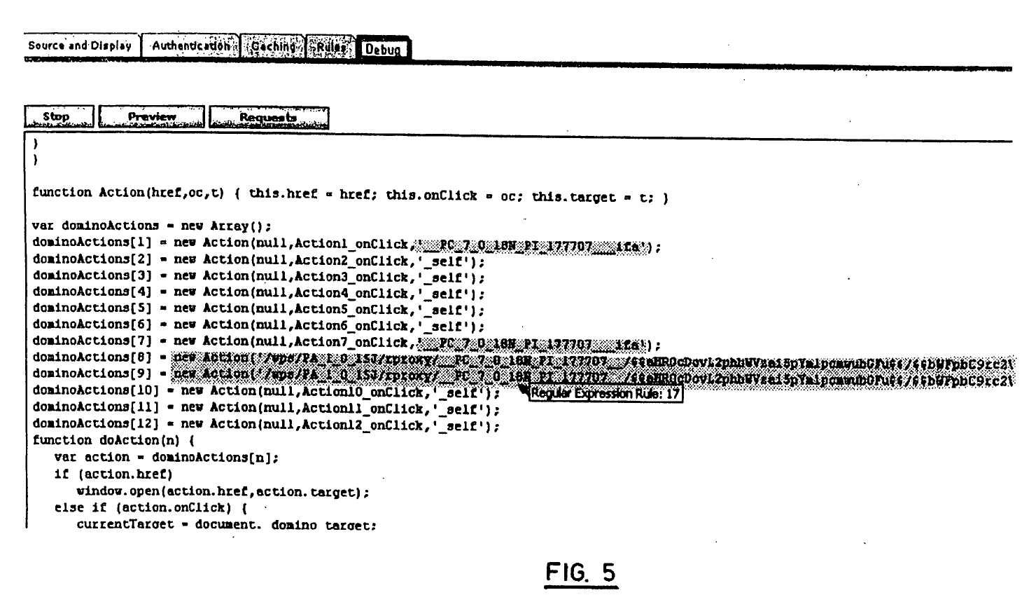

For the same request, clicking on the “Transformed” link on the request page 44 will bring up a screen like that shown in FIG. 5, which is produced by rendering the modified transformed HTML 36. This screen displays in text format the corresponding transformed HTML. Again, by hovering a cursor over a particular piece of highlighted text the user can cause a pop-up message to be displayed. This time the message indicates the rule 20 which was applied in the transformation.

The transformation engine 18 can be implemented as a “reverse proxy portlet,” which can be installed on a portal page like any other portlet, and which acts as a window through which users interact with the back-end application. The reverse proxy portlet provides a highly customizable solution to reverse proxying, where rules can be created for every individual transformation requirement. The configuration rules of the portlet comprise the set of pattern matching rules to identify and rewrite URLs in received content. These rules can be configured for individual applications. The reverse proxy portlet rewrites all URLs contained in the source HTML 26 to point to the portlet itself rather than to the backend server.

Portlets have a number of different modes which can be selected, some of which are available only to a portlet developer or system administrator. The normal mode of operation of a portlet is the view mode, which is how the portlet is usually initially displayed to a user. A portlet may also support a help mode, which may provide a help page to enable users to obtain more information about the portlet. In the configure mode of a portlet, a portal developer or administrator can alter the configuration rules of the portlet. In an embodiment of the present invention, in the configure mode of the reverse proxy portlet the administrator is able to select a new “debug” feature which functions as described above.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the preceding example embodiments, the invention is not limited thereto and that there are many possible variations and modifications which fall within the scope of the invention. For example, the tool may be used in any rules-based transformation engine, and although the preferred embodiment has been described in relation to the transformation of HTML, the tool could be applied to the transformation of any kind of markup or text. Such modifications and variations that may be apparent to a person skilled in the art are intended to be included within the scope of this invention as defined by the accompanying claims.

What we claim is:

1. A method of monitoring a transformation of source markup by a rules-based transformation engine, the method comprising:
storing a set of rules;
scanning the source markup and generating edit information in accordance with the set of rules;
transforming the source markup into transformed markup in accordance with the rules;
modifying at least one of the source markup and transformed markup in accordance with the edit information; and
rendering the modified markup to highlight those portions affected by transformations.

2. The method of claim 1, wherein the rules identify a plurality of target character patterns and associated output models, the method further comprising scanning the source markup for character strings corresponding correctly to any of the target character patterns.

3. The method of claim 2, in which transforming the source markup comprises replacing any matched character strings in the source markup in accordance with the output model associated with the matched character pattern.

4. The method of claim 1, wherein generating edit information comprises generating markers identifying a beginning and end of each matching character string and the rule to which the string matches.

5. The method of claim 4, in which the source markup is transformed according to the edit information.

6. The method of claim 4, in which modifying source markup comprises adding tags to highlight any matching character string.

7. The method of claim 4, in which modifying transformed markup comprises adding tags to highlight any replacement character string.

8. The method of claim 1, wherein the modifying step includes the addition of tags to enable a display of data identifying a rule in response to user selection of a highlighted portion of modified markup.

9. The method of claim 1, wherein the modifying step includes inserting escape sequences to enable special characters to be displayed to a user.

10. A rules-based transformation engine for transforming source markup in accordance with a set of rules, the engine comprising:
a matching component for scanning the source markup and generating edit information in accordance with a set of rules;
a transforming component for transforming the source markup into transformed markup in accordance with the rules;
a text modifier for receiving the source markup, transformed markup, and edit information and modifying at least one of the source markup and transformed markup in accordance with the edit information; and
a rendering component for rendering the modified markup to highlight those portions affected by transformations.

11. The engine of claim 10, wherein the rules identify a plurality of target character patterns and associated output models, and the matching component scans the source markup for character strings corresponding correctly to any of the target character patterns.

12. The engine of claim 1 1, wherein the transforming component replaces any matched character strings in the source markup in accordance with the output model associated with the matched character pattern.

13. The engine of claim 10, wherein the matching component generates markers identifying a beginning and end of each matching character string and the rule to which the string matches.

14. The engine of claim 13, in which the transformation component transforms the source markup in accordance with the edit information.

15. The engine of claim 13, wherein the text modifier modifies the source markup by adding tags to highlight any matching character string.

16. The engine of claim 13, wherein the text modifier modifies the transformed markup by adding tags to highlight any replacement character string.

17. The engine of claim 10, wherein the text modifier adds markup tags to enable a display of data identifying a rule in response to user selection of a highlighted portion of modified markup.

18. The engine of claim 10, wherein the text modifier inserts escape sequences into the markup to enable special characters to be rendered for display to a user.

19. The engine of claim 10, for use in a reverse proxy mechanism for proxying one or more applications running on a backend server in response to a request from a client computer system, the transformation engine being configured to transform responses from the backend server in accordance with the rules and comprising a logging component for recording information concerning requests and responses as well as for storing the modified markup.

20. A tool for monitoring a transformation of source markup by a rules-based transformation engine comprising a set of rules, a matching component for scanning the source markup and generating edit information in accordance with the set of rules; and a transforming component for transforming the source markup into transformed markup in accordance with the rules, the tool comprising:
a text modifier for receiving the source markup, transformed markup and edit information and modifying at least one of the source markup, and transformed markup in accordance with the edit information; and
a rendering component for rendering the modified markup to highlight those portions affected by transformations.

21. An article of manufacture including code for implementing a tool for monitoring a transformation of source markup by a rules-based transformation engine comprising a set of rules, a matching component for scanning the source markup and generating edit information in accordance with the set of rules; and a transforming component for transforming the source markup into transformed markup in accordance with the rules; wherein the code comprises computer-implementable instructions to:
receive the source markup, transformed markup, and edit information and modify at least one of the source markup and transformed markup in accordance with the edit information; and
render the modified markup to highlight those portions affected by transformations.
